(19) United States
(12) Patent Application Publication
(10) Pub. No.: US 2012/0099699 A1
(43) Pub. Date: Apr. 26, 2012

(54) Sample cup holding device

(76) Inventor: Monte J. Solazzi, Palm City, FL (US)

(21) Appl. No.: 12/925,577

(22) Filed: Oct. 25, 2010

(51) Int. Cl. G01N 23/223; B23P 11/00; G01N 37/00

(52) U.S. Cl. 378/44; 378/208; 29/428

(57) ABSTRACT

Sample cup holding devices including a base member with a top side, a bottom side, and one or more apertures extending from the top side to the bottom side, each of the one or more apertures for receiving a sample cup and maintaining the sample cup in a substantially vertical position, and a method for using same are provided.

### FIELD OF THE INVENTION

The invention relates generally to sample cup holding devices, and more particularly, to sample cup holding devices for use in X-ray spectroscopy.

### BACKGROUND OF THE INVENTION

Sample cups are used in X-ray spectroscopy to determine the characteristics or properties of various substances. The sample substances are disposed in a sample cup, which has a thin-film of material disposed across one end of the cup, and the substance is subjected to analysis in an instrumentation chamber, where X-ray beams impinge upon the thin-film.

After one or more sample substances are contained in one or more sample cups, the cups must be transported to the analysis chamber. Handling the sample cups may cause unwanted contamination, particularly if the thin-film of material is touched or damaged by wrinkling or tearing. Elimination of any contamination possibilities is one of the goals in obtaining the most accurate and precise data. Convenience to the user is also desirable, in transporting the assembled sample cups to an analysis chamber of the instrumentation.

There remains a need for a sample cup holding device that provides ease of usage and substantially eliminates the possibility of contamination for use in X-ray spectroscopy.

### SUMMARY OF THE INVENTION

According to an aspect of the invention, a sample cup holding device including a base member with a top side, a bottom side, and one or more frustoconical recesses extending from the top side to the bottom side, each of the one or more frustoconical recesses being tapered at a selected angle for receiving a sample cup and maintaining the sample cup in a substantially vertical position is described.

According to an aspect of the invention, a sample cup holding device including a base member with a top side, a bottom side, and one or more apertures extending from said top side to said bottom side, each aperture including one or more stepped portions, each of the stepped portions configured for receiving a sample cup of a selected dimension and maintaining the sample cup in a substantially vertical position.

According to another aspect of the invention, a method including the steps of preparing one or more spectroscopy sample cups, each of the cups containing an analyte; disposing the one or more spectroscopy analyte-containing sample cups in a sample cup holding device, the device including a base member with a top side, a bottom side, and one or more apertures extending from the top side to the bottom side, each of the one or more apertures configured for receiving a sample cup and maintaining the sample cup in a substantially vertical position is also described.

### BRIEF DESCRIPTION OF THE DRAWINGS

Throughout the drawings, like reference numerals are used to indicate common features of the described devices.

FIG. 1 is a front elevational view illustrating the sample cup holding device according to an aspect of the invention;

FIG. 2A is a top plan view illustrating the sample cup holding device of FIG. 1 according to an aspect of the invention;

FIG. 2B is a cross-sectional view illustrating the sample cup holding device of FIG. 1 according to an aspect of the invention;

FIG. 3 is a front elevational view illustrating the sample cup holding device according to an aspect of the invention;

FIG. 4A is a top plan view illustrating the sample cup holding device of FIG. 3 according to an aspect of the invention;

FIG. 4B is a cross-sectional view illustrating the sample cup holding device of FIG. 3 according to an aspect of the invention;

FIG. 5 is an elevational view illustrating a single sample cup holding device according to an aspect of the invention;

FIG. 6 is an elevational view illustrating a single sample cup holding device according to an aspect of the invention; and

FIG. 7 is an elevational view illustrating a sample cup holding device in context.

The above-identified drawing figures set forth several preferred embodiments of the invention. Other embodiments are also contemplated, as disclosed herein. The disclosure represents the invention, but is not limited thereby, as it should be understood that numerous other modifications and embodiments may be devised by those skilled in the art which fall within the scope and spirit of the invention as claimed.

### DETAILED DESCRIPTION OF THE INVENTION

As used herein, the terms “comprises”, “comprising”, “includes”, “including”, “has”, “having”, or any other variation thereof, are intended to cover non-exclusive inclusions. For example, a process, method, article or apparatus that comprises a list of elements is not necessarily limited to only those elements but may include other elements not expressly listed or inherent to such process, method, article, or apparatus. In addition, unless expressly stated to the contrary, the term “of” refers to an inclusive “or” and not to an exclusive “or”. For example, a condition A or B is satisfied by any one of the following: A is true (or present) and B is false (or not present); A is false (or not present) and B is true (or present); and both A and B are true (or present).

The terms “a” or “an” as used herein are to describe elements and components of the invention. This is done for convenience to the reader and to provide a general sense of the invention. The use of these terms in the description herein should be read and understood to include one or at least one. In addition, the singular also includes the plural unless indicated to the contrary. For example, reference to a composition containing “a compound” includes one or more compounds. As used in this specification and the appended claims, the term “or” is generally employed in its sense including “and/or” unless the content clearly dictates otherwise.

All numeric values are herein assumed to be modified by the term “about,” whether or not explicitly indicated. The term “about” generally refers to a range of numbers that one of skill in the art would consider equivalent to the recited value (i.e., having the same function or result). In any instances, the terms “about” may include numbers that are rounded to the nearest significant figure.

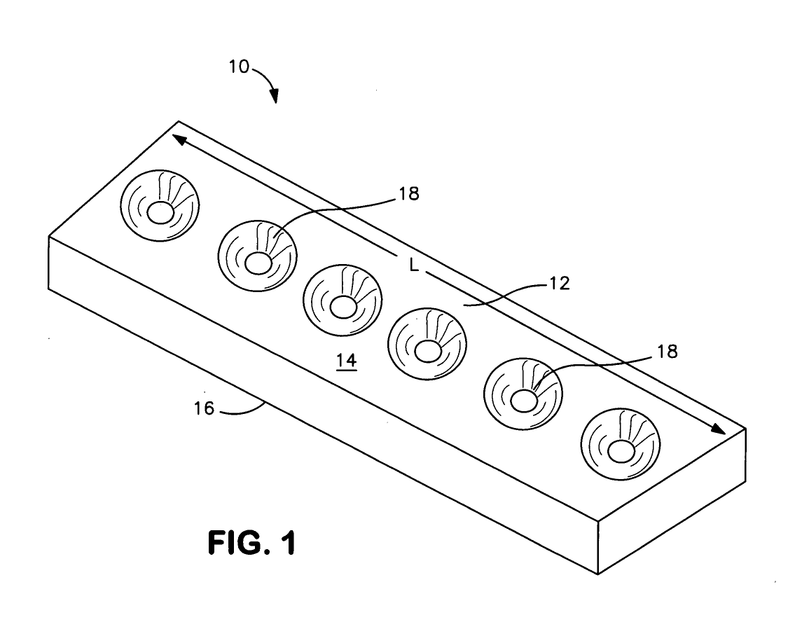

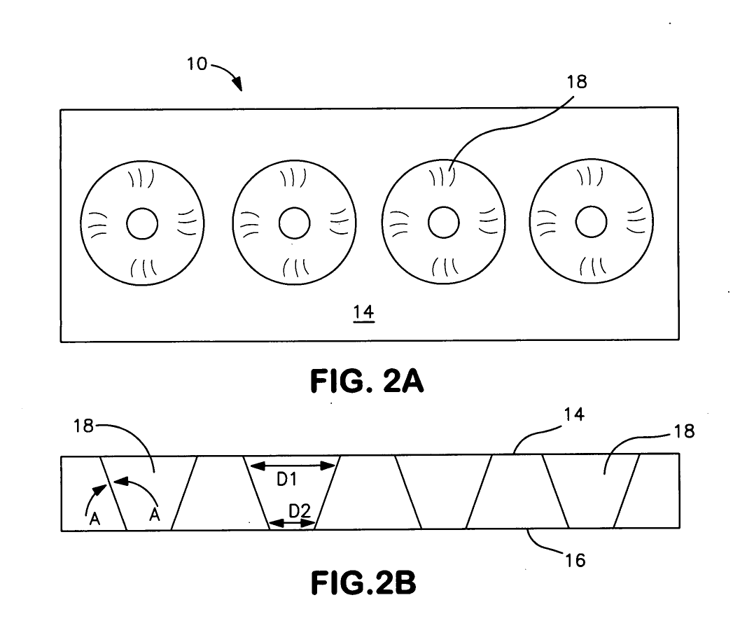

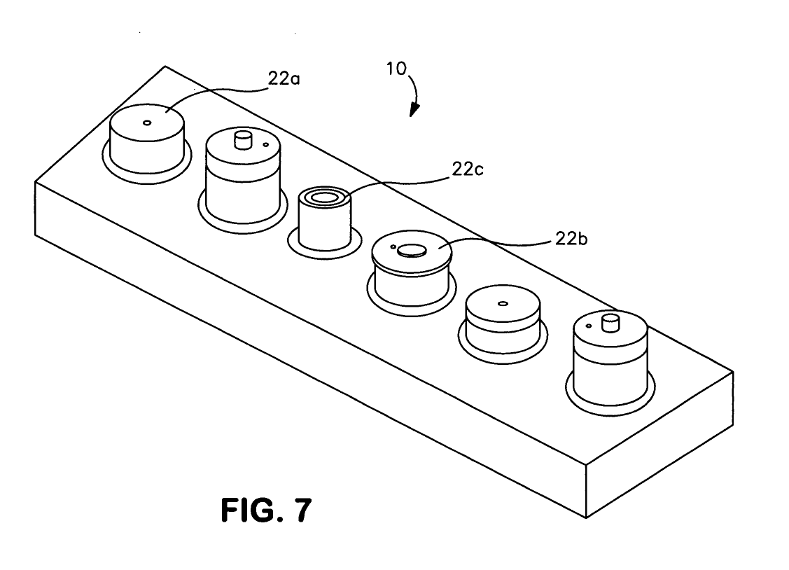

Referring to FIG. 1, according to an aspect of the invention, a sample cup holding device 10 includes a base member 12 with a top side 14, an opposite bottom side 16, and one or more frustoconical recesses 18 extending from the top side 14 to the bottom side 16, each of the one or more frustoconical recesses 18 being tapered at a selected angle A (FIG. 2B) for receiving a sample cup 22 (FIG. 7) and maintaining said sample cup 22 in a substantially vertical and level position. The diameter of each of the one or more frustoconical recesses 18 on the top side 14 decreases from D1 on the top side 14 to D2 on the bottom side 16.

As illustrated in FIG. 1, base member 12 is substantially rectangular, and each of the one or more frustoconical recesses 18 are distributed along a length L of the top side 14. Six recesses 18 are shown in FIG. 1, but there may be more or less present on the device. The selected tapering angle A may be between about 40 degrees to about 50 degrees. According to an aspect of the invention, the selected angle A may be about 45 degrees. It should be understood that the selected angle is not critical, and that many different angles may be used, provided that the sample cup will be maintained in a suitable fashion, i.e., in a substantially vertical and level position. Device 10 may be useful in instrumentation designed to accept multiple samples requiring advanced sample preparation in readiness for batch analysis.

Referring to FIGS. 2A and 2B, top plan and cross-sectional views of the device 10 of FIG. 1 are illustrated. Although only four frustoconical recesses 18 are shown, it should be understood that additional recesses 18 may be present on the device 10, as illustrated in FIG. 1. FIG. 2B illustrates the frustoconical recesses 18, and the diameter D1 that diminishes from the top side 14 to the bottom side 16, where the diameter is D2.

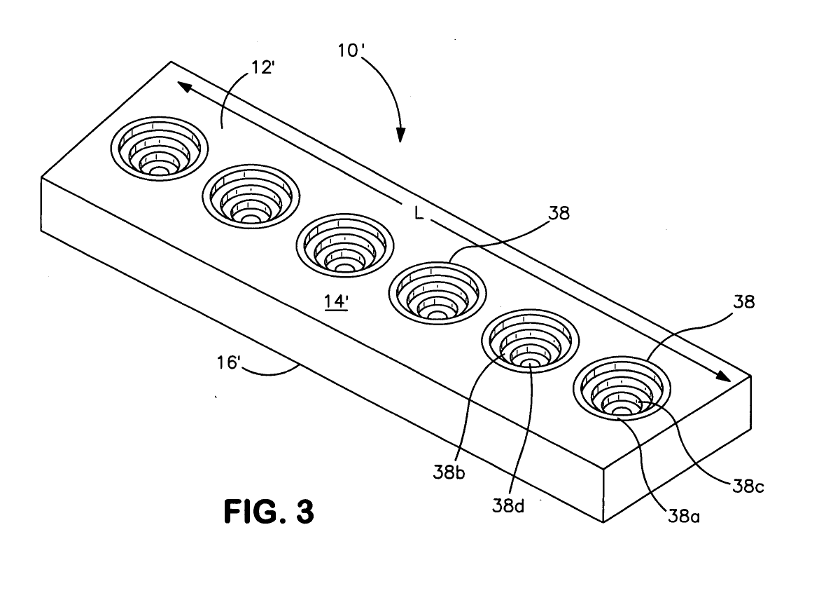

Referring to FIG. 3, according to another aspect of the invention, a sample cup holding device 10′ includes a substantially rectangular base member 12′ with a top side 14′, an opposite bottom side 16′, and one or more apertures 38 extending from the top side 14′ to the bottom side 16′ along the length L thereof. Each aperture 38 includes one or more stepped portions 38a, 38b, 38c, and 38d. Each of the stepped portions or annular recesses is configured for receiving a sample cup 22 (FIG. 7) of a selected dimension and maintaining the sample cup 22 in a substantially vertical and level position.

As used herein, the term “stepped portions” refers to any configuration of an annular recess that transitions from a stepwise or incremental manner from one diameter to a different diameter. It should be understood that the individual stepped portions may be made a right angles (oriented 90 degrees from the major plane), or may be of other stepped transitional geometry (beveled, concave and convex, for example). The diameters of the stepped portions 38a-38d decrease from the top side 14′ to the bottom side 16′ to accommodate different sizes of sample cups 22. It should be understood that the selected diameters of the stepped portions 38a-38d are not critical, and that many different diameters may be employed.

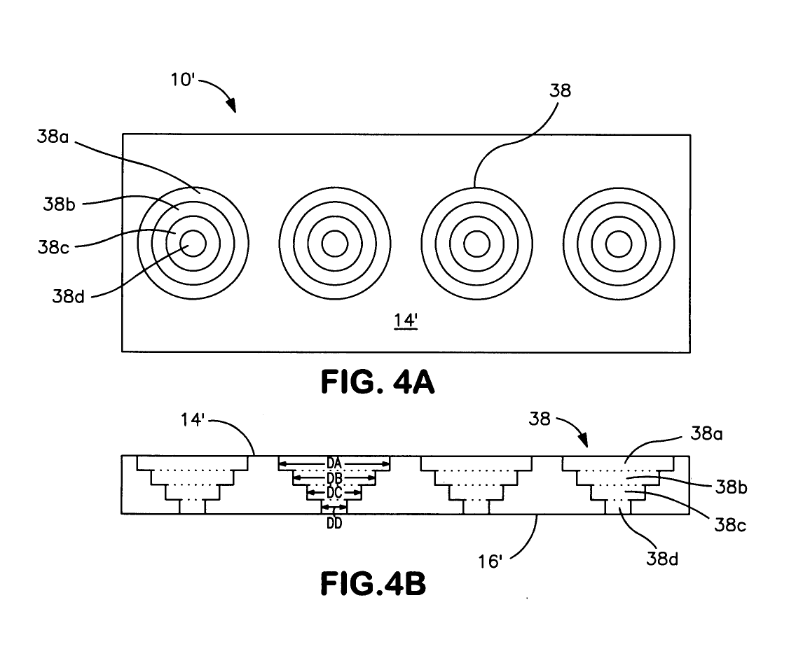

Referring to FIGS. 4A and 4B, a top plan and cross-sectional view of the device 10′ of FIG. 3 is illustrated. Although only four apertures 38 are shown, it should be understood that additional apertures 38 may be present on the device 10′, as illustrated in FIG. 3. FIG. 4B illustrates the stepped portions 38a, 38b, 38c, and 38d in cross-section, and the diameters of each stepped portion, DA, DB, DC, and DD, respectively. As illustrated, the diameters of the stepped portions decrease from DA on the top side 14′ to DD on the bottom side 16′.

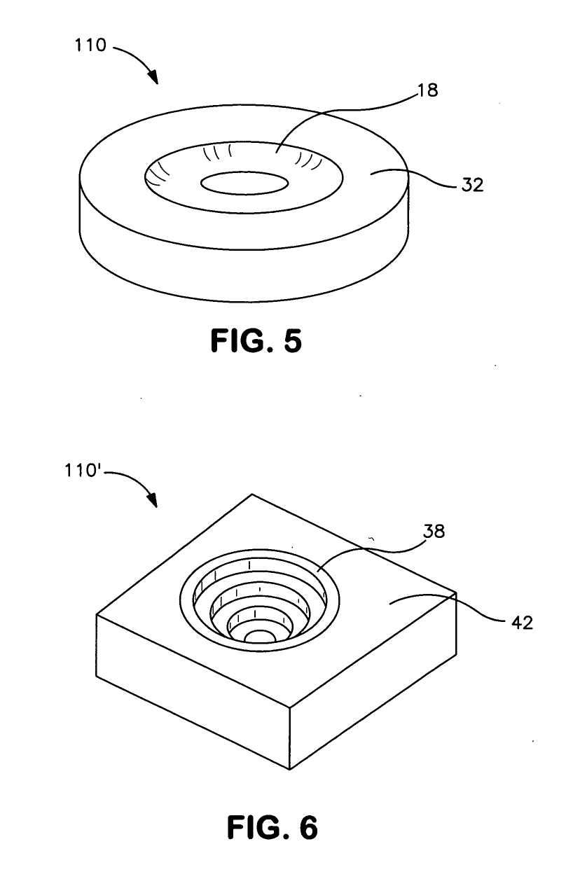

Referring to FIG. 5, according to another aspect of the invention, the sample cup holding device 110 has a base member 32 that is substantially cylindrical. In this aspect, only one frustoconical recess 18 is present on the device 110. The frustoconical recess 18 is centrally disposed on the base member 32. According to this aspect of the invention, the device 110 may be useful in instrumentation that analyzes one sample at a time, with a reasonable amount of time between cycles for the user to prepare another sample for analysis. It should be understood that an aperture 38 with one or more stepped portions 38a-38d (as illustrated in FIG. 6) alternatively may also be present on the device 110.

Referring to FIG. 6, according to another aspect of the invention, the sample cup holding device 110′ has a base member 42 that is substantially rectangular or cubic. In this aspect, only one aperture 38 with stepped portions 38a-38d is present on the device 110′. The aperture 38 is centrally disposed on the base member 42. According to this aspect of the invention, the device 110′ may be useful in instrumentation that analyzes one sample at a time, with a reasonable amount of time between cycles for the user to prepare another sample for analysis. It should be understood that a frustconical recess 18 (as illustrated in FIG. 5) alternatively may also be present on the device 110′.

Referring to FIG. 7, which illustrates a variety of commercially-available sample cups 22 disposed on the device 10 of FIG. 1 of FIG. 3, a user would prepare the sample cups 22 by assembling the cups 22 and disposing an analyte into each of the cups 22. One or more sample cups 22 are disposed on the device 10, 10′, 110 and 110′. As illustrated in FIG. 7, some cups have caps with vent holes 22a, some caps have knobs and vent holes 22b, and some cups may be left open 22c. Numerous sample cups suitable for use according to the invention are commercially-available from Chemplex Industries, Inc., the assignee herein.

Each device 10, 10′, 110 and 110′ may be configured to receive sample cups 22 having a diameter ranging between about 24 to about 45 mm. By using the devices described herein, a user can easily dispose prepared sample cups in the devices, and place one or more devices in an analysis chamber for subjection to spectroscopic analysis, including X-ray fluorescence, for example. It should be understood that the thin-film of material that covers an open end of the assembled sample cup(s) is disposed adjacent the bottom side of the device, which protects the film from contamination, as it is held a selected distance in the device from the analysis chamber.

The devices 10, 10′, 110 and 110′ may be composed of a rigid plastic, for example, polyethylene, polypropylene, polycarbonate, or other suitable plastic material. It should be understood that the composition of the device is not a limiting factor, but it should be suitable for use in X-ray spectroscopy.

The invention has been described with reference to specific embodiments. One of ordinary skill in the art, however, appreciates that various modifications and changes can be made without departing from the scope of the invention as set forth in the claims. For example, although the base member may be rectangular according to an aspect of the invention, the base member may take many forms, dependent upon the shape of the analysis chamber. Accordingly, the specification is to be regarded in an illustrative manner, rather than with a restrictive view, and all such modifications are intended to be included within the scope of the invention.

Benefits, other advantages, and solutions to problems have been described above with regard to specific embodiments. The benefits, advantages, and solutions to problems, and any element(s) that may cause any benefits, advantages, or solutions to occur or become more pronounced, are not to be construed as a critical, required, or an essential feature or element of any or all of the claims.

1. A sample cup holding device, comprising:
a base member comprising a top side, a bottom side, and one or more frustoconical recesses extending from said top side to said bottom side, each of said one or more frustoconical recesses being tapered at an angle between about 40 degrees to about 50 degrees, configured for receiving a sample cup and maintaining said sample cup in a substantially vertical position.

2. The sample cup holding device according to claim 1, wherein the diameter of each of said one or more frustoconical recesses decreases from said top side to said bottom side.

3. The sample cup holding device according to claim 1, wherein said base member is substantially rectangular.

4. The sample cup holding device according to claim 3, wherein two or more of said one or more frustoconical recesses are distributed along a length of said top side.

5. The sample cup holding device according to claim 3, wherein one of said one or more frustoconical recesses is centrally disposed.

6. The sample cup holding device according to claim 1, wherein said base member is substantially cylindrical.

7. The sample cup holding device according to claim 6, wherein one of said one or more frustoconical recesses is centrally disposed.

8. A sample cup holding device, comprising:
a base member comprising a top side, a bottom side, and one or more apertures extending from said top side to said bottom side, each aperture comprising a plurality of stepped portions, each of said stepped portions configured for receiving a sample cup having a diameter between about 24 mm to about 45 mm and maintaining said sample cup in a substantially vertical position.

9. The sample cup holding device according to claim 8, wherein the dimensions of said stepped portions decrease from said top side to said bottom side.

10. The sample cup holding device according to claim 8, wherein said base member is substantially rectangular.

11. The sample cup holding device according to claim 10, wherein said one or more apertures are distributed along a length of said top side.

12. The sample cup holding device according to claim 10, wherein one of said one or more apertures is centrally disposed.

13. The sample cup holding device according to claim 8, wherein said base member is substantially cylindrical.

14. The sample cup holding device according to claim 13, wherein one of said one or more apertures is centrally disposed.

15. The sample cup holding device according to claim 8, wherein one of said stepped portions transitions to an adjacent one of said stepped portions at a 90 degree angle.

16. A method, comprising the steps of:
preparing one or more spectroscopy sample cups, each of said cups containing an analyte;
disposing said one or more spectroscopy analyte-containing sample cups in a sample cup holding device, said device comprising:
a base member comprising a top side, a bottom side, and one or more frustoconically-shaped apertures extending from said top side to said bottom side, each of said one or more apertures configured for receiving a sample cup and maintaining said sample cup in a substantially vertical position.

17. The method according to claim 16, further comprising the steps of placing said device in an analysis chamber; and subjecting the analyte contained in said one or more spectroscopy sample cups to spectroscopic analysis.

18. The method according to claim 17, wherein said spectroscopic analysis is X-ray fluorescence.
